(19) United States
(12) Patent Application Publication
(10) Pub. No.: US 2007/0234517 A1
(43) Pub. Date: Oct. 11, 2007

(54) Overmolded hinge with insert washer

(76) Inventors: George D. Larson, Roseville, MN (US); John Kossett, Vadnais Heights, MN (US)

Correspondence Address: DICKE, BILLIG & CZAJA, FIFTH STREET TOWERS, 100 SOUTH FIFTH STREET, SUITE 2250, MINNEAPOLIS, MN, 55402, US

(21) Appl. No.: 11/398,008

(22) Filed: Apr. 5, 2006

(51) Int. Cl. E05D 11/08

(52) U.S. Cl. 16/342

(57) ABSTRACT

An overmolded hinge includes a first bracket, a second bracket, a shaft assembly and a first washer. The second bracket is hinged relative to the first bracket. The shaft assembly further includes a shaft and the shaft extends through at least a portion of each of the inner and outer brackets. The first washer is fitted over the shaft and is located between the first and second brackets. The first and second brackets are molded over the shaft assembly and are molded within mold inserts during an overmolding process. The first washer is supported by the mold inserts such that no portion of the shaft assembly contacts the mold insert during the overmolding process.

### BACKGROUND

The present invention relates to an overmolded friction torque hinge. Friction hinge devices are well known in the art to support objects at selected angular positions relative to a main body. In addition, it is often useful to utilize overmolding techniques with friction hinge devices in order to easily fabricate friction hinges that are uniquely configured to particular applications. For example, injection molding processes can be used to overmold a friction hinge. However, some overmolding techniques cause certain portions of the torque hinge device to remain exposed. Leaving portions of the torque hinge exposed can potentially cause vulnerability for the fabricating hinge device.

For these and other reasons, there is a need for the present invention.

### SUMMARY

The present invention is an overmolded hinge. The overmolded hinge includes a first bracket, a second bracket, a shaft assembly and a first washer. The second bracket is hinged relative to the first bracket. The shaft assembly further includes a shaft and the shaft extends through at least a portion of each of the inner and outer brackets. The first washer is fitted over the shaft and is located between the first and second brackets. The first and second brackets are molded over the shaft assembly and are molded within mold inserts during an overmolding process. The first washer is supported by the mold inserts such that no portion of the shaft assembly contacts the mold insert during the overmolding process.

### BRIEF DESCRIPTION OF THE DRAWINGS

The accompanying drawings are included to provide a further understanding of the present invention and are incorporated in and constitute a part of this specification. The drawings illustrate the embodiments of the present invention and together with the description serve to explain the principles of the invention. Other embodiments of the present invention and many of the intended advantages of the present invention will be readily appreciated as they become better understood by reference to the following detailed description. The elements of the drawings are not necessarily to scale relative to each other. Like reference numerals designate corresponding similar parts.

FIG. 1 illustrates an exploded view of an overmolded hinge in accordance with one embodiment of the present invention.

FIG. 2 illustrates a cross-sectional view of an overmolded hinge in accordance with one embodiment of the present invention.

FIGS. 3A and 3B each illustrate half-portions of mold inserts used in fabricating overmolded hinges in accordance with one embodiment of the present invention.

FIG. 4 illustrates a partial cross-sectional view of a seal used in an overmolded hinge in accordance with one embodiment of the present invention.

FIG. 5 illustrates an exploded view of an overmolded hinge with a seal in accordance with one embodiment of the present invention.

FIG. 6 illustrates an exploded view of an alternative overmolded hinge in accordance with one embodiment of the present invention.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

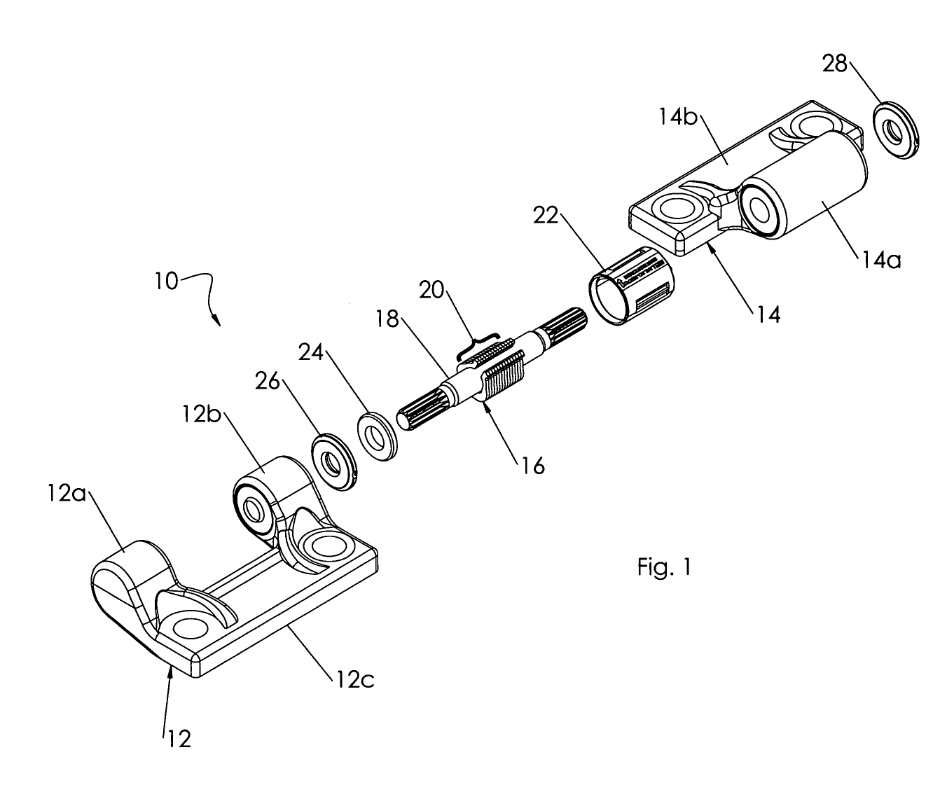

FIG. 1 illustrates overmolded hinge 10 in accordance one embodiment of the present invention. Overmolded hinge 10 includes outer bracket 12, inner bracket 14, torque assembly 16, and first and second insert washers 26 and 28. When fully assembled, overmolded hinge 10 can provide relatively constant rotational torque between outer and inner brackets 12 and 14. In addition, in one embodiment first and second insert washers 26 and 28 are configured to fit snuggly between outer and inner brackets 12 and 14 so that torque assembly 16 remains substantially concealed within the combination of outer and inner brackets 12 and 14 and first and second insert washers 26 and 28.

In one embodiment, torque assembly 16 of overmolded hinge 10 further includes shaft 18, a plurality of clips 20, housing 22, and end cap 24. In one embodiment, shaft 18 has a center portion over which clips 20 are mounted, and this portion of shaft 18, along with clips 20, are overmolded with inner bracket 14, and specifically with overmolded portion 14a. Shaft 18 also includes knurled portions containing raised ribs at both ends over which outer bracket 12 is mounted, and specifically with overmolded portions 12a.

In one embodiment, clips 20 are mounted on shaft 18 such that they are frictionally engaged therewith. Clips 20 are mounted side-by-side such that they are in contact with each other. In one embodiment a fully assembled torque assembly 16 includes housing 22 placed over the plurality of clips 20 over shaft 18. End of cap 24 is then placed adjacent housing 22 in order to seal clips 20 within housing 22 and end cap 24. Shaft 18 rotates with outer bracket 12, because its ends are embedded therein (in overmolded portions 12a). Clips 20 rotate with inner bracket 14, because they are embedded therein (in overmolded portion 14a). It is the frictional engagement between the clips 20 and shaft 18 that provide frictional torque as outer and inner brackets 12 and 14 are rotated relative to each other.

In one embodiment, the plurality of clips 20 are configured to mate with housing 22 such that they rotate together. As such, when inner bracket 14 is formed over housing 22, it will rotate with both housing 22 and clips 20. In another embodiment, inner bracket 14 is formed directly over clips 20, and no housing 22 or cap 24 is used. As such, inner bracket 14 is coupled directly to clips 20 so that they rotate together.

One skilled in the art will also understand that a variety of other torque packages can be provided as torque assembly 16. For example, a solid wrap could be used in place of the plurality of clips 20 to create interference with shaft 18 thereby generating friction torque. Similarly, a wrap spring could be substitutes for clips 20 to create interference and friction torque. A variety of other torque packages are similarly possible.

First and second insert washers 26 and 28 are then placed on torque assembly 16. Specifically, first and second insert washers 26 and 28 are snuggly fitted over shaft 18 on either side of the plurality of clips 20 and/or housing 22 (or along side any of the variety of alternative torque-producing designs). Outer and inner brackets 12 and 14 are then molded over torque assembly 16 on either side of first and second insert washers 26 and 28, which are then located between outer and inner brackets 12 and 14 after they are formed. In this way, no portion of torque assembly 16, and specifically no portion of shaft 18, is exposed after overmolded hinge 10 is finally formed.

Fully covering torque assembly 16, including shaft 18, provides environmental and cosmetic advantages for overmolded hinge 10. In prior designs where shaft 18 is left opened to the environment after assembled, it can be exposed to wear and damage. For example, when shaft 18 is metallic, leaving it exposed to outside environment can lead to rusting and/or discoloration. Providing first and second insert washers 26 and 28 is also useful in the process of forming outer and inner brackets 12 and 14 as will be discussed more fully below.

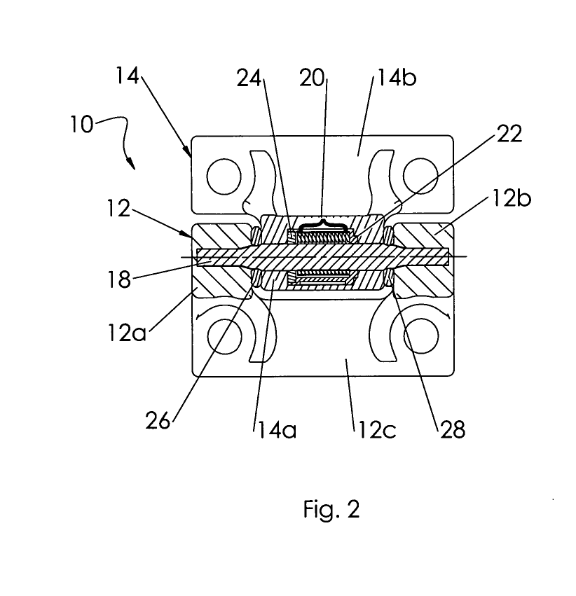

FIG. 2 illustrates a sectional view of overmolded hinge 10 in accordance with one embodiment of the present invention. Overmolded hinge 10 includes outer bracket 12, inner bracket 14, shaft 18, clips 20, housing 22, end cap 24, and first and second insert washers 26 and 28. Overmolded hinge 10 is shown fully assembled in FIG. 2. Outer bracket 12 includes overmolded portions 12a and 12b and mounting portion 12c. Both ends of shaft 18 are embedded in overmolded portions 12a and 12b of outer bracket 12. Mounting portion 12c of outer bracket 12 may then be used to mount overmolded hinge 10 to a hinged body.

Inner bracket 14 includes overmolded portion 14a and mounting portion 14b. A center portion of shaft 18, the plurality of clips 20, and housing 22 with end cap 24 are all illustrated embedded within overmolded portion 14a of bracket 14. Similarly to mounting portion 12c above, mounting portion 14b of inner bracket 14 can be used to mount overmolded hinge 10 to a hinged body.

First and second insert washers 26 and 28 are located between outer and inner brackets 12 and 14 along shaft 18. Specially, first insert washer 26 is located between overmolded portion 14a of inner bracket 14 and overmolded portion 12a of outer bracket 12. Similarly, second insert washer 28 is located between overmolded portion 14a of inner bracket of 14 and overmolded portion 12b of outer bracket 12. As such, there is no space or opening between outer and inner brackets 12 and 14 so that no portion of shaft 18 is exposed once overmolded hinge 10 is fully assembled.

In prior applications that do not include first and second insert washers 26 and 28, a space is typically left between outer and inner brackets 12 and 14 where first and second insert washers 26 and 28 are illustrated. As such, these spaces allow exposure of shaft 18 to external elements, thereby causing potential damage. For example, where shaft 18 is metallic, it could rust and corrode. Furthermore, a gap between outer and inner brackets 12 and 14 along the length of shaft 18 can cause problems in vertical applications. For example, where outer and inner brackets 12 and 14 are mounted to vertically-oriented hinged elements such that shaft 18 extends in a vertical direction, outer and/or inner brackets 12 and 14 can be forced to shift along shaft 18 over the amount of the gap between them. This vertical shifting can cause failures, faults or damage in the particular application.

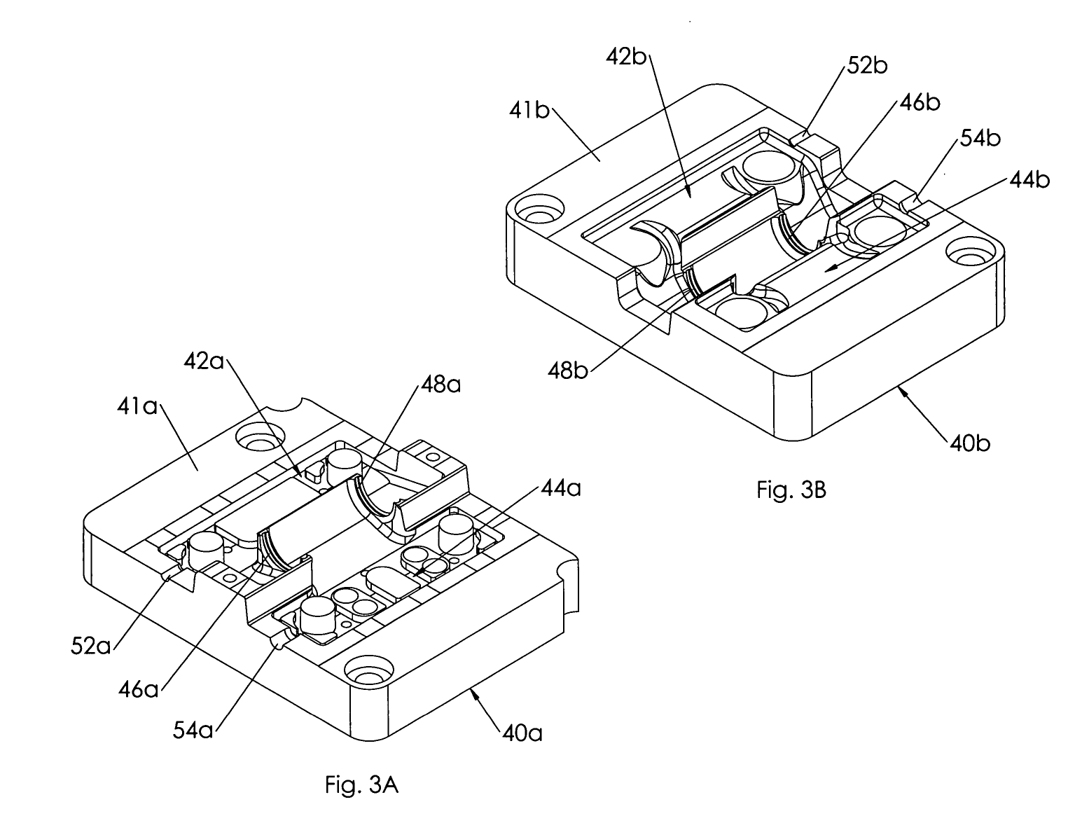

FIGS. 3A and 3B illustrate mold inserts 40a and 40b in which hinges, such as overmolded hinge 10, can be formed. Lower mold insert 40a is illustrated in FIG. 3A and upper mold insert 40b is illustrated in FIG. 3B. Lower mold insert 40a includes mold surface 41a, outer bracket cavity 42a, inner bracket cavity 44a, first washer groove 46a, second washer groove 48a, outer bracket gate 52a, and inner bracket gate 54a. Similarly, upper mold insert 40b includes mold surface 41b, outer bracket cavity 42b, inner bracket cavity 44b, first washer groove 46b, second washer groove 48b, outer bracket gate 52b, and inner bracket gate 54b.

In order to form overmolded hinge 10 within mold inserts 40a and 40b, torque assembly 16 is placed within the mold inserts so that outer and inner brackets 12 and 14 can be molded over torque assembly 16. In one embodiment, torque assembly 16 includes shaft 18 and a plurality of clips 20 placed over a center portion of shaft 18. Then, first and second insert washers 26 and 28 are also placed over torque assembly 16, and specifically, over shaft 18 adjacent the plurality of clips 20. Torque assembly 16 with first and second insert washers 26 and 28 placed thereon is then placed within mold inserts 40a and 40b such that first and second insert washers 26 are aligned with first washer grooves 46a/46b and second washer grooves 48a/48b, respectively.

In this way, when upper and lower mold inserts 40a and 40b are placed tightly together so that mold surfaces 41a and 41b touching, first and second insert washers 26 and 28 are tightly held and supported within upper and lower mold inserts 40a and 40b by first and second washer grooves 46a/46b and 48a/48b. Since first and second insert washers 26 and 28 are firmly placed over torque assembly 16, torque assembly 16 is also support within upper and lower mold inserts 40a and 40b.

In one embodiment, flowable material is then injection molded around torque assembly 16 by injecting the flowable material into outer and inner bracket gates 52a/52b and 54a/54b in accordance with known injection molding techniques. Since torque assembly 16 is supported within upper and lower mold inserts 40a and 40b via first and second insert washers 26 and 28, no portion of torque assembly 16 contacts any surface of upper and lower mold inserts 40a and 40b so that flowable material is able to completely surround torque insert 16. In this way, all portions of torque assembly 16, other than where first and second insert washers 26 and 28 are placed, will be covered by the flowable material.

Flowable material that enters outer bracket gate 52a/52b flows into and fills outer bracket cavity 42a/b, thereby forming outer bracket 12. In particular, flowable material surrounds shaft 18 in overmolded portions 12a and 12b (see FIG. 2, for example). In one embodiment, shaft 18 is knurled with raised ribs in these portions so that there is a tight interconnection of shaft 18 and overmolded portions 12a and 12b. As such, shaft 18 will rotate with any rotation of outer bracket 12.

Similarly, flowable material that enters inner bracket gate 54a/54b flows into and fills inner bracket cavity 44a/b, thereby forming inner bracket 14. In particular, flowable material surrounds the center portion of shaft 18, including clips 20 and/or housing 22 in overmolded portion 14a (see FIG. 2, for example). Where housing 22 is used, there is a tight interconnection between it and overmolded portion 14a, and where no housing 22 is used there is a tight interconnection between clips 20 and overmolded portion 14a. In any case, clips 20 and/or housing 22 will rotate with any rotation of inner bracket 14.

In one embodiment, outer bracket cavity 42a/42b and inner bracket cavity 44a/44b are separated by first and second insert washers 26 and 28 once upper and lower mold inserts 40a and 40b fixed together. In other words, if first and second insert washers 26 and 28 are not placed within first and second washer grooves 46a/46b and 48a/48b, flowable material would freely flow between outer bracket cavity 42a/42b and inner bracket cavity 44a/44b. As such, with first and second insert washers 26 and 28 placed within first and second washer grooves 46a/46b and 48a/48b, the flowable material within outer bracket cavity 42a/42b that forms outer bracket 12 abuts tightly against the “outside” surfaces of first and second insert washers 26 and 28. And similarly, the flowable material within inner bracket cavity 44a/44b that forms inner bracket 14 abuts tightly against the “inside” surfaces of first and second insert washers 26 and 28.

Furthermore, since outer bracket cavity 42a/42b and inner bracket cavity 44a/44b are separated by first and second insert washers 26 and 28, and “single shot” injection molding process can be used. In other words, flowable material can be injected into both outer and inner bracket gates 52a/52b and 54a/54b at the same time. Upper and lower mold inserts 40a and 40b can be left sealed together throughout the process as torque assembly 16 does not need to be adjusted.

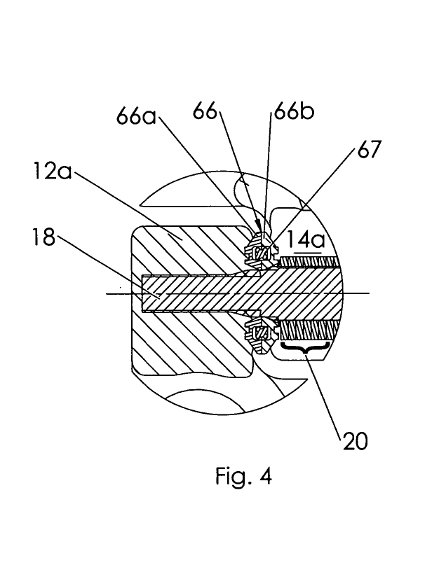

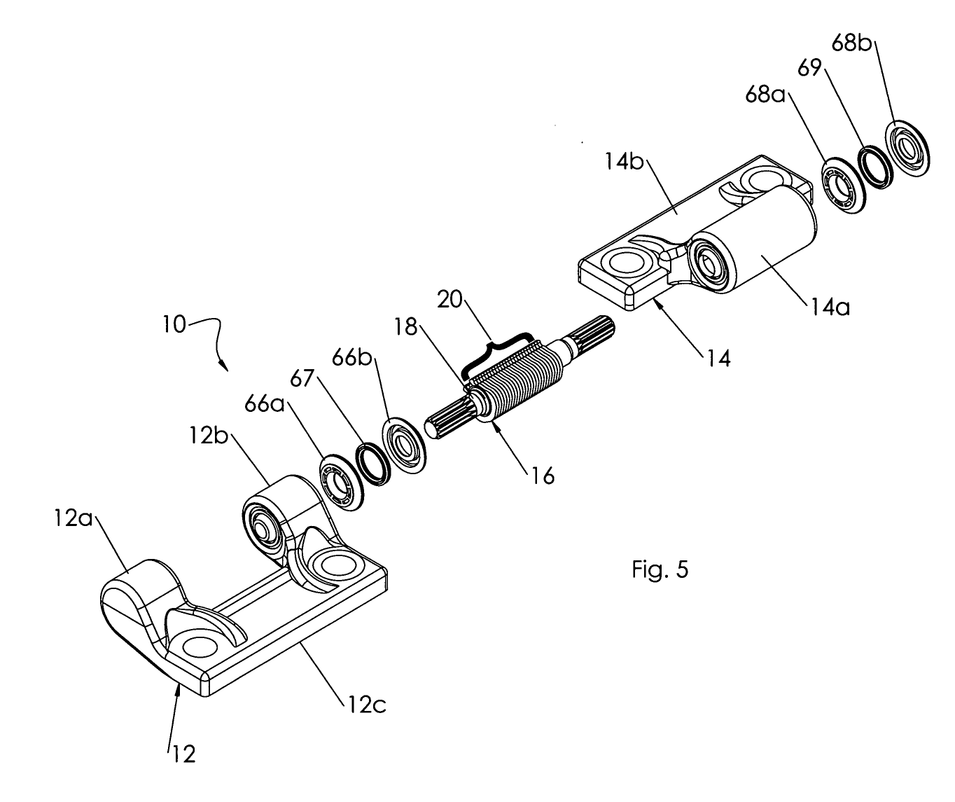

FIGS. 4 and 5 respectively illustrate partial cross-sectional and exploded views of an alternative embodiment of overmolded hinge 10 in accordance with an embodiment of the present invention. Overmolded hinge 10 of FIGS. 4 and 5 is highly similar to that described above with respect to FIGS. 1-3. First and second split washers 66 and 68 in FIGS. 4 and 5, however, differ from first and second insert washers 26 and 28 in FIGS. 1-2, and thus, split washers 66 and 68 are discussed more fully below. Discussions of similar portions of overmolded hinge 10 are not repeated.

First split washer 66 includes outer face portion 66a, inner face portion 66b and radial seal 67. Similarly, second split washer 68 includes inner face portion 68a, outer face portion 68b and seal 69. Because split washers 66 and 68 are three-piece washers, they can be configured so one face piece turns with one bracket and another face piece turns with another bracket.

As such, outer face portion 66a of first split washer 66 is configured to abut up against overmolded portion 12a of outer bracket 12 such that outer face portion 66a rotates with any rotation of outer bracket 12. Inner face portion 66b of first split washer 66 is configured to abut up against overmolded portion 14a (the left side as illustrated in FIG. 5) of inner bracket 14 such that inner face portion 66b rotates with any rotation of inner bracket 14. When overmolded hinge 10 is in typical operation, outer and inner brackets 12 and 14 rotate in opposite directions, and thus, so do outer and inner face portions 66a and 66b. Radial seal 67 helps facilitate a good seal between the counter rotation of outer and inner face portions 66a and 66b.

Similarly, inner face portion 68a of second split washer 68 is configured to abut up against overmolded portion 14a (the right side as illustrated in FIG. 5) of inner bracket 14 such that inner face portion 68a rotates with any rotation of inner bracket 14. Outer face portion 68b of second split washer 68 is configured to abut up against overmolded portion 12b of outer bracket 12 such that outer face portion 68b rotates with any rotation of outer bracket 12. When overmolded hinge 10 is in typical operation, outer and inner brackets 12 and 14 rotate in opposite directions, and thus, so do outer and inner face portions 68a and 68b. Radial seal 69 helps facilitate a good seal between the counter rotation of outer and inner face portions 68a and 68b.

Each of washers 26, 28, 66 and 68 are configured to provide a seal for torque assembly 16 such that shaft 18 is not exposed once overmolded hinge 10 is fully assembled. This can be important in protecting shaft 18 as well as providing cosmetic advantages. Furthermore, by preventing gaps between the brackets 12 and 14, the washers 26, 28, 66, and 68 provide thrust load capacity allowing hinge 10 to be used in vertical-mounted applications without allowing the brackets 12 and 14 to slip relative to each other along shaft 18. The split washers 66 and 68 further provide a smooth rotational feel between brackets 12 and 14 during their relative rotation. Washers 26 and 28 similarly can provide a smooth rotational feel between brackets 12 and 14 through a proper choice of lubricated plastic.

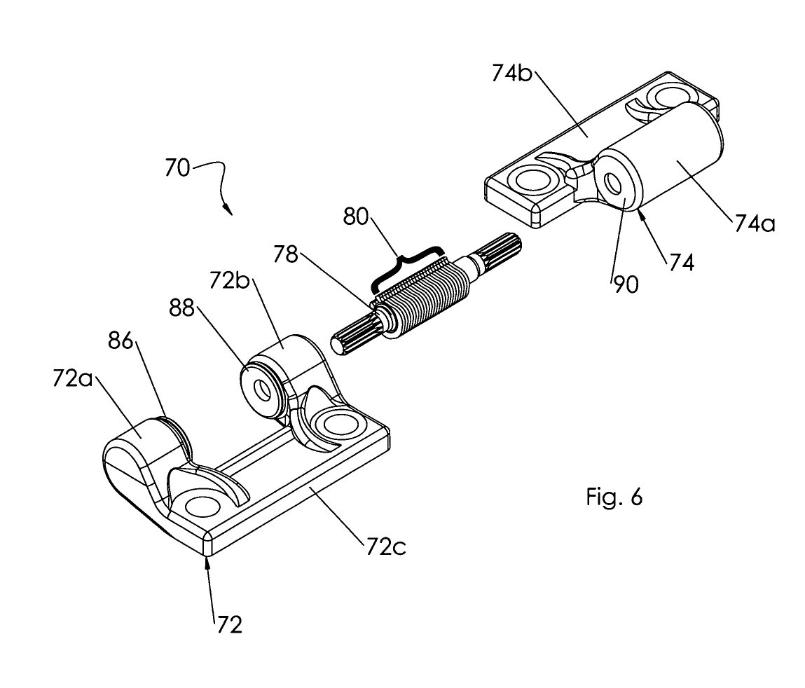

In one embodiment, washers such as washers 26, 28, 66 and 68, can be integrated into one and/or both of brackets 12 and 14. For example, FIG. 6 illustrates overmolded hinge 70 in accordance with one such alternative embodiment of the invention. Overmolded hinge 70 includes outer bracket 72, inner bracket 74, shaft 78, a plurality of clips 80, and first and second integrated washers 86 and 88. When fully assembled, overmolded hinge 70 can provide relatively constant rotational torque between outer and inner brackets 72 and 74.

In the embodiment illustrated in FIG. 6, first and second integrated washers 86 and 88 are integrated into outer bracket 72. As such, mold inserts, such as inserts 40a and 40b in FIG. 6 are modified so that first and second integrated washers 86 and 88 are formed with outer bracket 72 when flowable material is injected into the mold inserts. Then, either that molded outer bracket 72 with integrated washers 86 and 88 is transferred to another mold insert for the formation of inner bracket 74, or the mold inserts are otherwise adjusted so inner bracket 74 can be formed with a second injection or shot. Inner bracket 74 is formed with a surface 90 that complements first integrated washer 86 so that they fit snuggly together over shaft 78. A similar surface (not visible in FIG. 6) complements second integrated washer 88 so that they fit snuggly together over shaft 78.

Integrated washers 86 and 88 of alternative overmolded hinge 70 also provide a seal for over shaft 78 and clips 80 so that shaft 78 is not exposed once overmolded hinge 70 is fully assembled. This can be important in protecting shaft 78 as well as providing cosmetic advantages. Furthermore, by preventing gaps between the brackets 72 and 74, integrated washers 86 and 88 allow hinge 70 to be used in vertical-mounted applications without allowing the brackets 72 and 74 to slip relative to each other along shaft 78.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

For example, in one variation of the invention, overmolded hinge 10 illustrated in FIG. 1 can be modified so that overmolded portion 12a or overmolded portion 12b is removed. In this modification only a single insert, split or similar washer is used between overmolded portion 14a of inner bracket 14 and either overmolded portion 12a of outer bracket 12 or overmolded portion 12b of outer bracket 12. The washer would still cover the shaft 18 between brackets 12 and 14, and it would still provide a means by which torque assembly 16 can be secured within mold inserts for the overmolding process.

In an additional example, one skilled in the art will recognize that portions of torque assembly 16 can be split between overmolded portions of inner bracket 14 and overmolded portions of outer bracket 12. For example, a plurality of clips 20 could be placed over shaft 18 within overmolded portion 14a of inner bracket 14 and/or within overmolded portion 12a of outer bracket 12 and/or within overmolded portion 12b of outer bracket 12. The overall relative length of overmolded portions 12a, 12b, and 14a can be easily varied in accordance with embodiments of the invention.

What is claimed is:

1. An overmolded hinge comprising:
a shaft assembly including an axially extending shaft;
a first molded bracket that is molded over a first portion of the shaft assembly;
a second molded bracket molded over a second portion of the shaft assembly such that the second bracket is hinged relative to the first bracket about the shaft; and
a first washer placed over the shaft and located between the first and second molded brackets.

2. The overmolded hinge of claim 1, wherein the first and second brackets are molded within mold inserts during an overmolding process, and wherein the first washer is supported by the mold inserts such that no portion of the shaft assembly contacts the mold insert during the overmolding process.

3. The overmolded hinge of claim 1, wherein the first washer is located immediately adjacent both the first and second brackets such that the first washer acts as a thrust washer preventing relative axial movement between the first and second brackets.

4. The overmolded hinge of claim 1, wherein the first washer and the first and second brackets cover the shaft such that no portion of the shaft is exposed.

5. The overmolded hinge of claim 1, wherein the shaft assembly further comprises a torque element configured such that torque is produced by the torque element as the first and second brackets are rotated relative to each other about the shaft.

6. The overmolded hinge of claim 5, wherein the torque element comprises a plurality of clips mounted tightly over the shaft such that there is friction between the shaft and clips upon counter rotation of the shaft and clips.

7. The overmolded hinge of claim 6, wherein the shaft is fixed to the first bracket and the clips are fixed to the second bracket such that torque is produced as the first and second brackets are rotated relative to each other, the torque being proportional to the number of clips mounted over the shaft.

8. The overmolded hinge of claim 7, wherein the shaft assembly further comprises a housing over the clips, wherein the shaft is fixed to the first bracket, wherein the clips are fixed to the housing and wherein the housing is fixed to the second bracket such that torque is produced as the first and second brackets are rotated relative to each other.

9. The overmolded hinge of claim 2, further comprising a second washer placed over the shaft and located adjacent at least one of the first and second brackets.

10. The overmolded hinge of claim 9, wherein the second washer is supported by the mold inserts such that no portion of the shaft assembly contacts the mold insert during the overmolding process.

11. The overmolded hinge of claim 10, wherein a flowable material is injected into the mold inserts during the overmolding process thereby forming the first and second brackets, and wherein all portions of the shaft assembly are covered with the flowable material, other than those portions where the first and second washers are placed.

12. The overmolded hinge of claim 9, wherein the first and second washers are split washers each having a first face portion, a second face portion and a radial seal therebetween, such that the first face portion of the first and second washers rotate with the first bracket and such that the second face portion of the first and second washers rotate with the second bracket, and such that the radial seal provides a seal between the counter rotating portions.

13. An overmolded hinge comprising:
first and second molded brackets hinged relative to each other;
a shaft extending through at least a portion of each of the first and second molded brackets and coupled to the first molded bracket such that the shaft rotates with the first molded bracket;
a torque element fitted over the shaft and enclosed within a portion of second molded bracket and coupled thereto so that torque is produced upon relative rotation of the first and second molded brackets; and
a first washer fitted firmly over the shaft and immediately adjacent both the first and second molded brackets so that the combination of the first and second molded brackets and first washer completely cover the shaft.

14. The overmolded hinge of claim 13, wherein the torque element comprises a plurality of clips fitted over a portion of the shaft and frictionally engaged therewith, the plurality of clips over the portion of the shaft being completely enclosed within a portion of second molded bracket and coupled thereto so that the clips rotate with the second molded bracket.

15. The overmolded hinge of claim 14, wherein the first molded bracket includes first and second overmolded portions that each contain the shaft, wherein the second molded bracket includes an overmolded portion located between the first and second overmolded portions of the first molded bracket, and wherein the overmolded portion of the second molded bracket contains the plurality of clips over the shaft.

16. The overmolded hinge of claim 15, further comprising a second washer fitted firmly over the shaft, wherein the first washer is located immediately adjacent and between the first overmolded portion of the first molded bracket and the overmolded portion of the second molded bracket, and wherein the second washer is located immediately adjacent and between the second overmolded portion of the first molded bracket and the overmolded portion of the second molded bracket so that the combination of the first and second molded brackets and the first and second washers completely cover the shaft.

17. The overmolded hinge of claim 16, wherein the first and second molded brackets are molded over the shaft and the clips, wherein the first and second molded brackets are molded within mold inserts during an overmolding process, and wherein the first and second washers are supported by the mold inserts such that no portion of the shaft or clips contact the mold insert during the overmolding process.

18. The overmolded hinge of claim 17, wherein the first and second washers are split washers each having a first face portion, a second face portion and an radial seal therebetween, such that the first face portion of the first and second washers rotate with the first molded bracket and such that the second face portion of the first and second washers rotate with the second molded bracket, and such that the radial seal provides a seal between the counter rotating face portions.

19. An overmolded hinge comprising:
an inner bracket;
an outer bracket hinged relative to the inner bracket;
a shaft extending through at least a portion of each of the inner and outer brackets;
a plurality of clips fitted over a portion of the shaft and frictionally engaged therewith, the plurality of clips and the portion of the shaft being completely enclosed within a portion of inner bracket; and
first and second washers fitted over the shaft;
wherein the first and second washers are located on each side of the plurality of clips and are located between the inner and outer brackets and covering the shaft so that no portion of the shaft is exposed.

20. An overmolded hinge comprising:
a first bracket;
a second bracket hinged relative to the first bracket;
a shaft assembly including a shaft, the shaft extending through at least a portion of each of the first and second brackets; and
a first washer placed over the shaft and located between the first and second brackets;
wherein the first and second brackets are molded over the shaft assembly and are molded within mold inserts during an overmolding process, and wherein the first washer is supported by the mold inserts such that no portion of the shaft assembly contacts the mold insert during the overmolding process.
